(19) United States
(12) Patent Application Publication
(10) Pub. No.: US 2022/0347821 A1
(43) Pub. Date: Nov. 3, 2022

(54) CONFIGURABLE LEVERAGE BIT DRIVER HANDLE

(71) Applicants: Zheng Huang, Chattanooga, TN (US); Chadwick Sterling Parker, Chattanooga, TN (US)

(72) Inventors: Zheng Huang, Chattanooga, TN (US); Chadwick Sterling Parker, Chattanooga, TN (US)

(21) Appl. No.: 17/305,359

(22) Filed: Jul. 6, 2021

Related U.S. Application Data
(60) Provisional application No. 63/181,928, filed on Apr. 29, 2021.

(51) Int. Cl. B25B 15/02; B25G 1/00; B25G 1/08; B25B 23/00; B25B 23/16

(52) U.S. Cl. CPC B25B 15/02; B25G 1/005; B25G 1/085; B25B 23/0028; B25B 23/16

(57) ABSTRACT

A configurable leverage bit driver includes a first elongate shaft having a first bit receiving socket in an end face of the distal end. A second elongate shaft is dimensioned to couple with the first elongate shaft in a first axially aligned bit driving configuration. At least one aperture is defined in a lateral side of the second elongate shaft and is dimensioned to selective couple with the first elongate shaft to configure the first elongate shaft and the second elongate shaft in a second bit driving configuration with the second elongate shaft oriented as a lever arm aligned in a transverse axis to the longitudinal axis of the first elongate shaft. The second bit driving configuration may be one or more of a T-handle or an offset T-handle bit driver for increased leverage in driving a fastener.

### CROSS-REFERENCE TO RELATED APPLICATION

This application claims the benefit of priority of U.S. provisional application No. 63/181,928 filed Apr. 29, 2021, the contents of which are herein incorporated by reference.

### BACKGROUND OF THE INVENTION

The present invention relates to hand tools, and more particularly to screwdriver and bit driver hand tools.

Traditional hand screwdrivers limited the torque, or twisting force that the user can apply to remove or secure a fastener. Due to the axial alignment of the gripping handle with the shaft of the driver, the developed torque is limited by the width of the handle and the user's ability to grip and twist the handle. Consequently, it is hard to apply a lot of pressure onto a traditional screwdriver.

As can be seen, there is a need for improved bit driver handle that is configurable to enhance the leverage and torque developed by the user to fasten or remove a fastener.

### SUMMARY OF THE INVENTION

In one aspect of the present invention, a configurable leverage bit driver handle is disclosed. The handle includes a first elongate shaft having a proximal end and a distal end. A first bit receiving socket is defined in an end face of the distal end. The proximal end having a polygonal cross section along a longitudinal axis of the first elongate shaft. A second elongate shaft has a first end, a second end, and an interior cavity dimensioned to couple with at least the proximal end of the first elongate shaft in a first bit driving configuration, axially aligned with the longitudinal axis of the first elongate shaft. At least one aperture is defined in a lateral side of the second elongate shaft. The at least one aperture is dimensioned to couple with the polygonal cross section of the first elongate shaft where the proximal end and the at least one aperture are selectively coupled to configure the first elongate shaft and the second elongate shaft in a second bit driving configuration with the second elongate shaft oriented as a lever arm aligned in a transverse axis to the longitudinal axis of the first elongate shaft.

The at least one aperture is defined proximal to a midpoint of the second elongate shaft. In this case, the configurable leverage bit driver handle may be configured in a T-shaped handle configuration.

The at least one aperture may be disposed at an intermediate position of the second elongate shaft between the first end and a midpoint of the second elongate shaft. In this case, the configurable leverage bit driver handle may be configured in an offset T-shaped handle configuration.

These and other features, aspects and advantages of the present invention will become better understood with reference to the following drawings, description and claims.

### BRIEF DESCRIPTION OF THE DRAWINGS

FIG. 1 is a side perspective view of the configurable leverage bit driver handle.

FIG. 2 is a side perspective view of the configurable leverage bit driver handle, shown in an axially aligned configuration.

FIG. 3 is a side elevation view of a leverage arm of the configurable leverage bit driver handle.

FIG. 4 is an exploded component view of the configurable leverage bit driver handle

FIG. 5 is a side elevation view of the configurable leverage bit driver handle shown in a T-drive configuration.

FIG. 6 is a side elevation view of the configurable leverage bid driver handle shown in an L-drive configuration.

FIG. 7 is a perspective view of a bit driver shaft of the configurable leverage bit driver handle.

FIG. 8 is a side elevation view of the configurable leverage bit driver handle shown in an axially aligned configuration.

FIG. 9 is a detail view of a pawl.

FIG. 10 is a composite view showing a left side elevation view of the configurable leverage bit driver handle in a stowed condition, a front elevation view shown in a stowed condition, a front elevation view in an axially aligned bit driving configuration, and a right-side elevation view.

FIG. 11 is a composite view showing the T-handle bit driving configuration, the axially aligned bit driving configuration, and the offset T-handle bit driving configuration.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide A configurable leverage bit driver handle that, depending on the selected configuration, allows the user to select a desired torque application to install or remove a fastener. The configurable leverage bit driver handle may also include an internal storage for retaining at least one driver bit.

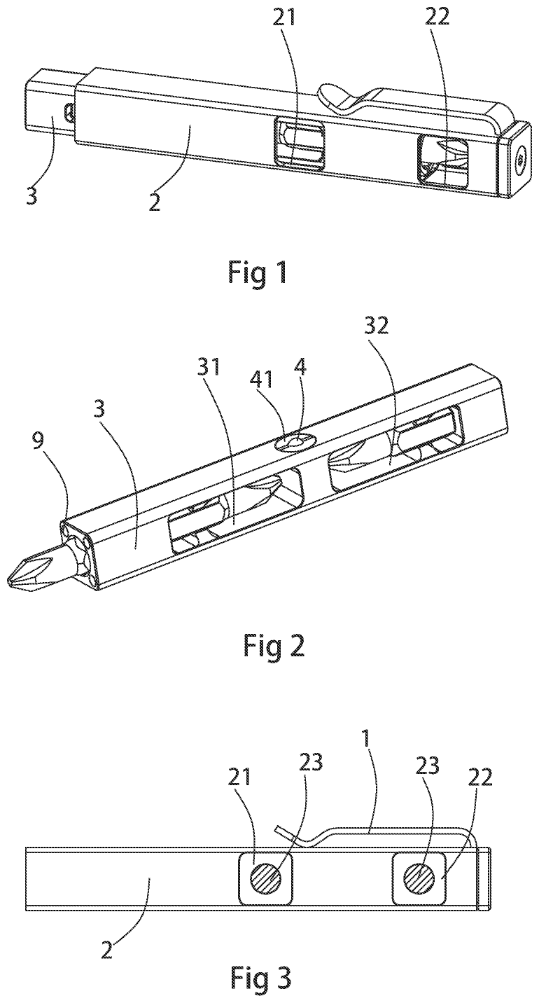

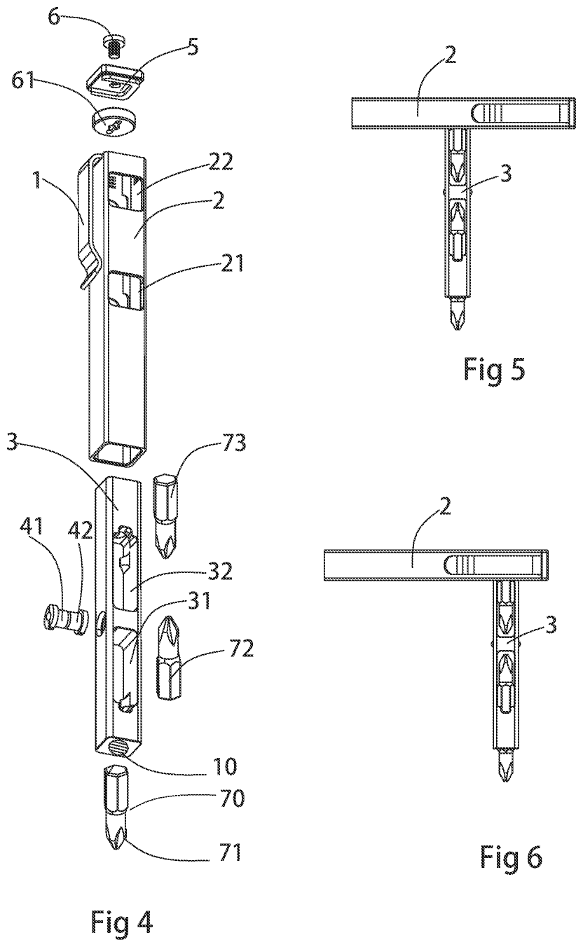

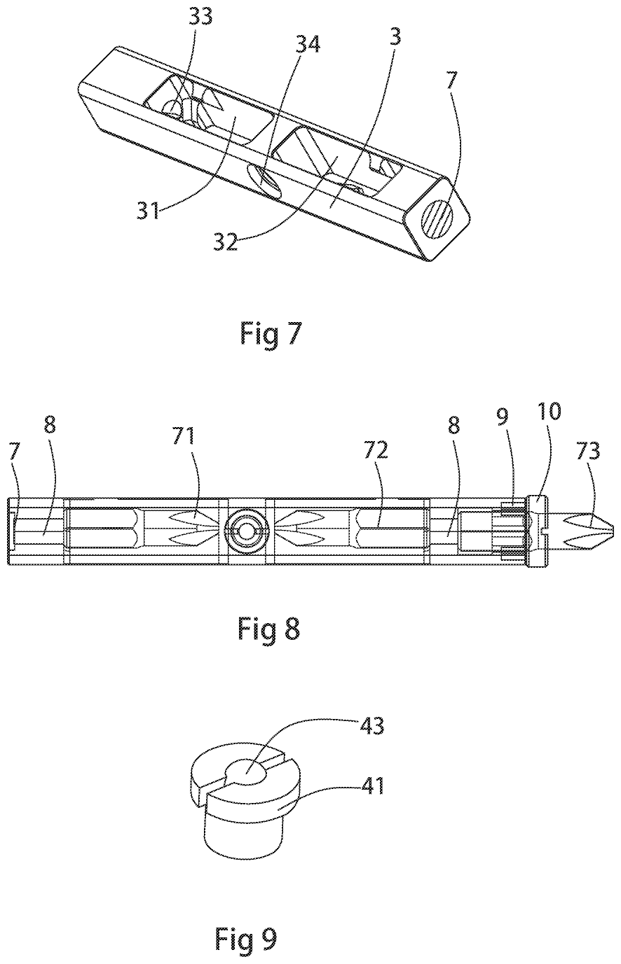

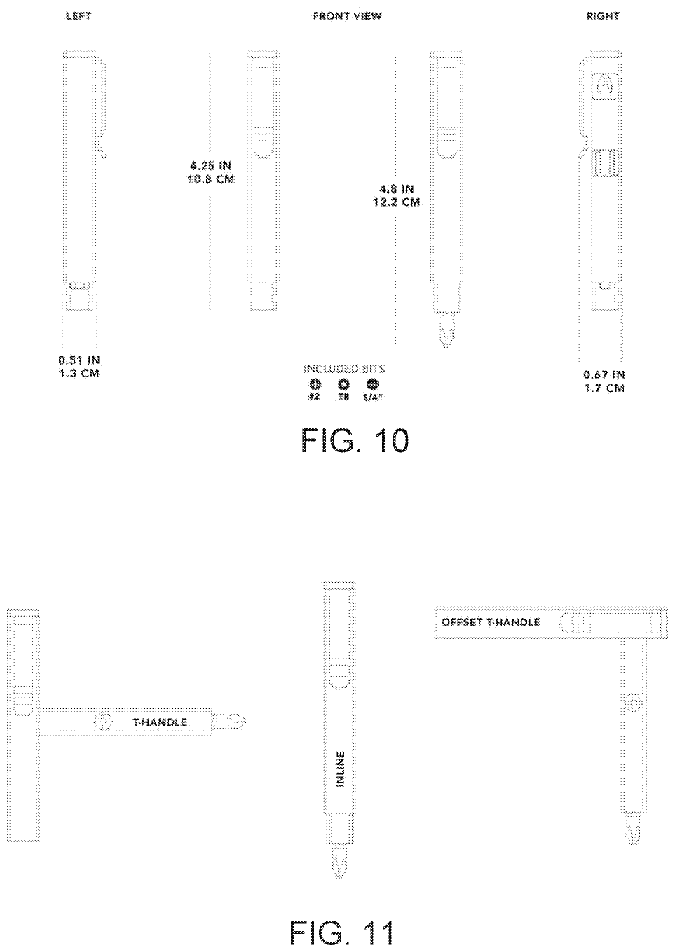

As seen in reference to the drawing of FIGS. 1-11, the configurable leverage bit driver handle includes a first elongate shaft 3 having a proximal end and a distal end. A first bit receiving socket 10 is defined in an end face of the distal end. The socket 10 may include a plurality of faces for engagement with a shaft 72 of a driver bit 70. The proximal end has a polygonal cross section along a longitudinal axis of the first elongate shaft. In the non-limiting embodiment shown, the polygonal cross section is a square shaped polygon.

One or more magnets 7, 8, 9 may be provided to retain the bits 70 when coupled or received within the bit driver handle. The magnet 7 facilitates retention of the first elongate shaft 3 when coupled with one or more of the first aperture 21 or the second aperture 22. Magnets 8, facilitate retention of the bits 70 within the cavities 31, 21. A third magnet 9, facilitates retention of the bit 70 within the bit receiving socket 10.

A second elongate shaft 2 has a first end, a second end, and an interior cavity dimensioned to couple with at least the proximal end of the first elongate shaft 3 in a first bit driving configuration. In the first bit driving configuration, the second elongate shaft is axially aligned with the longitudinal axis of the first elongate shaft 3. Preferably, the interior cavity is dimensioned to receive a majority of the first elongate shaft 3 in a nested storage configuration within the second elongate shaft 2. A retaining clip 1, may be attached to the second end of the second elongate shaft 2, for retaining the tool on a pocket, a tool belt, or the like.

At least one aperture 21, 22 is defined in a lateral side of the second elongate shaft 2. The at least one aperture 21, 22 is dimensioned to couple with the polygonal cross section of the first elongate shaft. In the non-limiting embodiment shown, the at least one aperture 21, 22 is square shaped. The proximal end of the first elongate shaft 3 and the at least one aperture 21, 22 are adapted to be selectively coupled to configure the first elongate shaft 3 and the second elongate shaft 2 in a second bit driving configuration with the second elongate shaft 2 oriented as a lever arm aligned in a transverse axis to the longitudinal axis of the first elongate shaft 3. The at least one aperture 21, 22 may extend through the second elongate shaft 2 to provide a more secure coupling and transfer of torque to the first elongate shaft 3. A ball bearing 23 has a spring loaded biasing in the back, it creates a tension when the first elongate shaft 3 is received in the second elongate shaft 2, so the first elongate shaft 3 doesn't fall out.

In some configurations, the at least one aperture 21 is defined proximal to a midpoint of the second elongate shaft 2. In other configurations, the at least one aperture 22 is disposed at an intermediate position of the second elongate shaft between the first end and a midpoint of the second elongate shaft 2. In other configurations, the at least one aperture 21, 22 includes a plurality of apertures, with a first aperture 21 defined at a midpoint of the second elongate shaft 2 and a second aperture 22 defined at the intermediate position of the second elongate shaft 2 between the first end and the midpoint of the second elongate shaft 2.

When coupled at the first aperture 21 at the midpoint, the configurable leverage bit driver is formed in a T-shaped bit driving configuration. The orientation of the second elongate shaft 2 in a transverse alignment with the longitudinal axis of the first elongate shaft 3 allows the user to develop additional torque on a fastener operated on by the driving bit 70 carried in the distal end of the first elongate shaft 3. The user may develop additional torque by grasping on the ends of the T-shaped handle formed by the second elongate shaft 2.

When coupled with the second aperture 22, the second elongate shaft 2 is positioned as a lever arm that allows the user to develop a maximum torque at the tip 72 of the driving bit 70 to secure or remove a corresponding fastener. The magnet 7 facilitates retention of the first elongate shaft 3 when coupled with one or more of the first aperture 21 or the second aperture 22.

The first elongate shaft may also include a bit cavity 31, 32. The bit cavity 31, 32 is dimensioned to releasably retain at least one driver bit 70. In the non-limiting embodiment shown, two bit cavities 31, 32 are provided. The number of bit cavities 31, 32 will depend upon the size of the configurable leverage bit driving handle, and the size of the driver bits 70.

The configurable leverage bit driver handle may also include a pawl 41 that operable between the first elongate shaft 3 and the second elongate shaft 42. The pa pawl 41, 42 has a ball 43 that is operable to releasably retain the first elongate shaft 3 in the nested storage configuration with the second elongate shaft 2.

A bumper 61 may be retained in the second end of the second elongate shaft 2 by an end plate 5, secured with a fastener 6. The bumper 61 is configured to abut one of the proximal end and the distal end of the first elongate shaft 3 when placed the first bit driving configuration or the nested storage configuration.

The configurable leverage bit driver handle may be utilized with a variety of driver bits 70 having a driver tip 71 and a shank 72. The driver tip 71 has any of a number of geometric shapes corresponding to a geometry of a fastener driven by the driver bit 70. The driver tip 72 is selected from the group consisting of a flat tip, a Phillips tip, a Torx tip, an Alan, a hexagonal socket, and a square tip.

As previously indicated, the configurable leverage bit driver handle may be sized according to a desired need and the size of the fasteners. In a pocket version in which the tool may be carried in, for example, a shirt pocket, the configurable leverage bit driver may have a length of about 4¼ inches and a width of about ½ inches. This embodiment can be suitable for lighter duty repair jobs. The configurable leverage bit driver may also be dimensioned for heavier duty repair jobs, such as automotive work, that may be carried in a glove box of a motor vehicle, or a toolbox.

It should be understood, of course, that the foregoing relates to exemplary embodiments of the invention and that modifications may be made without departing from the spirit and scope of the invention as set forth in the following claims.

What is claimed is:

1. A configurable leverage bit driver handle, comprising:
a first elongate shaft having a proximal end and a distal end, a first bit receiving socket in an end face of the distal end, the proximal end having a polygonal cross section along a longitudinal axis of the first elongate shaft;
a second elongate shaft having a first end, a second end, and an interior cavity dimensioned to couple with at least the proximal end of the first elongate shaft in a first bit driving configuration, axially aligned with the longitudinal axis of the first elongate shaft; and
at least one aperture defined in a lateral side of the second elongate shaft, the at least one aperture dimensioned to couple with the polygonal cross section of the first elongate shaft, wherein the proximal end and the at least one aperture are selectively coupled to configure the first elongate shaft and the second elongate shaft in a second bit driving configuration with the second elongate shaft oriented as a lever arm aligned in a transverse axis to the longitudinal axis of the first elongate shaft.

2. The configurable leverage bit driver handle of claim 1, wherein the at least one aperture is defined proximal to a midpoint of the second elongate shaft.

3. The configurable leverage bit driver handle of claim 1, wherein the at least one aperture is disposed at an intermediate position of the second elongate shaft between the first end and a midpoint of the second elongate shaft.

4. The configurable leverage bit driver handle of claim 1, wherein the at least one aperture is a plurality of apertures, with a first aperture defined at a midpoint of the second elongate shaft, and a second aperture defined at an intermediate position of the second elongate shaft between the first end and the midpoint of the second elongate shaft.

5. The configurable leverage bit driver handle of claim 4, further comprising:
a bit cavity defined in the first elongate shaft, the bit cavity dimensioned to releasably retain at least one driver bit.

6. The configurable leverage bit driver of claim 1, wherein the interior cavity is dimensioned to receive a majority of the first elongate shaft in a nested storage configuration.

7. The configurable leverage bit driver handle of claim 6, further comprising:
a pawl operable between the first elongate shaft and the second elongate shaft, the pawl operable to releasably retain the first elongate shaft in the nested storage configuration with the second elongate shaft.

8. The configurable bit driver of claim 7, further comprising:
a second bit receiving socket defined in an end face of the proximal end of the first elongate shaft.

9. The configurable bit driver of claim 8, further comprising:
a bumper retained in a second end of the second elongate shaft, the bumper configured to abut one of the proximal end and the distal end of the first elongate shaft when placed the first bit driving configuration or the nested storage configuration.

10. The configurable bit driver of claim 9, further comprising:
a driver bit having a driver tip and a shank, the driver tip having a geometric shape corresponding to a geometry of a fastener driven by the driver bit.

11. The configurable bit driver of claim 10, wherein the driver tip is selected from the group consisting of a flat tip, a Phillips tip, a Torx tip, and a square tip.
